(19) United States
(12) Patent Application Publication
(10) Pub. No.: US 2010/0199698 A1
(43) Pub. Date: Aug. 12, 2010

(54) REFRIGERATION DEVICE

(75) Inventor: Tetyana Lapchenko, Heidenheim (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/679,700

(22) PCT Filed: Sep. 11, 2008
(86) PCT No.: PCT/EP08/62079

§ 371 Date: Mar. 24, 2010

(30) Foreign Application Priority Data
Oct. 2, 2007 (DE) 10 2007 047 116.7

(51) Int. Cl. F25D 21/00; F25B 39/02; C09K 5/04

(52) U.S. Cl. 62/272; 62/515

(57) ABSTRACT

A refrigeration device having an insulated interior in which at least one refrigerated component part, such as an evaporator, is located and wherein the surface of the component part has a tendency to ice up. According to an exemplary embodiment of the invention, the surface tending to ice up is provided with a coating comprising organic substances which restrict or limit the growth of ice crystals.

The invention relates to a refrigeration device according to the pre-characterizing clause of claim 1.

In refrigeration devices such as e.g. refrigerators, chest freezers or upright freezers, an insulated interior space is provided which is typically delimited by the internal walls of a refrigerated container and the inside face of a door. The articles to be refrigerated are stored in the refrigerated container. A refrigerant circuit through which a refrigerant circulates is used in order to cool the interior compartment. The refrigerant is cooled down intensely in an evaporator. The evaporator is contained in the interior space requiring to be cooled. It extracts the heat from the air in the interior and transfers it to the refrigerant, which conveys the thermal energy to the outside of the refrigeration device and releases it there into the surrounding air. The evaporator generally has a temperature that lies below the freezing point of water.

Known types of evaporator are e.g. what are termed wire tube evaporators in which steel tubing is welded onto wire bars, thereby producing a relatively stable grid. In another well-known type of evaporator, aluminum tubes are fixed to thin-walled aluminum plates. It is also known to bend a temperature-conducting metal tube into a serpentine shape and to attach plastic parts on both sides in order to stabilize the structure. These evaporators are then inserted into the refrigeration device in a plurality of levels, the lateral plastic parts serving for fixing to the internal walls of the refrigerated container and at the same time acting as sliding rails for containers for accommodating the goods that are to be refrigerated.

A common feature of all these evaporators is that the moisture of the air contained within the interior space condenses on them and forms a layer of ice. The rate at which the layer of ice forms is dependent e.g. on how often the door of the refrigeration device is opened, how long the door remains open on average, and how high the moisture content of the ambient air is.

The layer of ice on the evaporator inhibits the transmission of heat from the air in the interior space of the refrigeration device to the refrigerant in the evaporator. As the layer of ice grows, more and more energy must therefore be expended in order to extract the heat from the interior space. The refrigeration device must therefore be defrosted at certain intervals in order to remove the layer of ice on the evaporator once again. In the case of refrigeration devices of elaborate or sophisticated design this defrosting process can be performed automatically, while more simply constructed refrigeration devices require the defrosting process to be performed manually. In both cases a not inconsiderable amount of heat is introduced into the refrigeration device. This heat input must be removed from the interior space again upon completion of the defrosting process.

The forming of a layer of ice on the evaporator consequently means increased energy consumption in each case. It must therefore always be considered at what thickness of the ice layer a defrosting process should be performed. For this purpose, too, methods have already been known for determining the thickness of the ice layer and in this way optimizing the frequency of the defrosting processes. In the case of all the refrigeration devices that have become known in the prior art it is, however, still necessary to perform said defrosting processes. Increased values for energy consumption are the result in the case of all known refrigeration devices, not only on account of the poor thermal conductivity of the ice layer that has formed on the evaporator but also on account of the defrosting process itself.

The object underlying the invention is to embody a refrigeration device according to the pre-characterizing clause of claim 1 in such a way that the formation of a layer of ice, in particular on the evaporator, can be prevented in order in this way to lower energy consumption.

The object is achieved according to the invention by means of a refrigeration device having the features recited in claim 1. In arctic regions life forms have been found which can survive even at the lowest temperatures, including when their body temperature drops below the freezing point of water. Thus, for example, insects have been discovered in Siberia which are still able to survive even at minus 60° C. These insects have a substance which prevents the growth of ice crystals. As a result the body fluids cannot transition to the crystalline state, nor can a layer of ice form on the surface of the body. These insects therefore do not go into a state of rigor and the locomotory system can also be supplied with the necessary nutrients. Such organic substances have meanwhile been found not only in insects but also in fish and plants. According to the invention such organic substances which prevent or restrict the growth of ice crystals are incorporated into a coating for surfaces in the interior space of a refrigeration device which have a tendency to ice up.

In this way a phenomenon known from nature can be applied to a technical application. The surfaces tending to ice up which are provided with said coating do not acquire any layer of ice. The transfer of heat from the air in the interior space of the refrigeration device to the refrigerant is thus not impaired by a layer of ice and the energy efficiency of the refrigeration device is improved. Furthermore, no defrosting processes need to be performed. Further energy savings can be made as a result.

The organic substances advantageously have synthetically created proteins or nucleic acids. In particular the subsequences which are responsible for what is termed the anti-freeze mechanism are created synthetically.

According to the invention the coating is built up on the basis of a peptide-functionalized substance, in particular as a protein lacquer. The peptides are modified during their synthesis so that they can be bound to the surface via binding molecules.

Particularly advantageously the coating is implemented as a lacquer. The coating for the surfaces tending to ice up can therefore be sprayed on in a simple manner or, alternatively, the corresponding component part is coated in an immersion process before it is installed in the refrigeration device.

In the case of a freezer it is advantageous to coat all component parts which have a temperature below the freezing point of water. Storage baskets, shelf supports but also the internal walls of the refrigerated container are also to be included in this. In the case of a refrigerator, on the other hand, it is sufficient to coat as appropriate the refrigerant-conducting component parts that run in the interior space. These parts include the evaporator, but also the inlet line to and the outlet line from the evaporator. In the case of a refrigeration device which is cooled via a Peltier element it is, of course, also beneficial to coat the cold side of the Peltier element in this way.

Further details and advantages of the invention will emerge from the dependent claims in conjunction with the description of an exemplary embodiment which is explained in greater detail with reference to the drawing, in which:

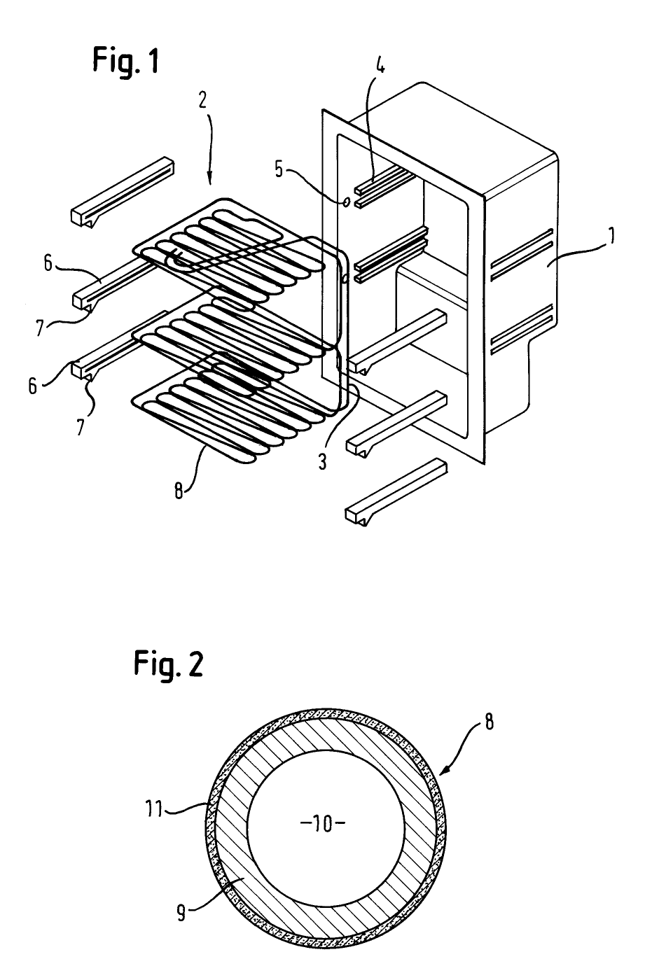

FIG. 1 shows an exploded view of the refrigerated container of a refrigeration device according to the invention, and

FIG. 2 shows a section through an evaporator tube coated according to the invention.

In FIG. 1 a plurality of tube evaporators 2 are combined with one another to form a modularly structured tube evaporator network. The connecting lines 3 between the individual tube evaporators 2 run in the interior space of the refrigeration device along the vertically running, right-hand rear edge of a refrigerated container 1.

In the exemplary embodiment shown here, three different tube evaporators are combined to form the tube evaporator network. The inlet and outlet of the tube evaporator network are provided on the top tube evaporator. The middle tube evaporator has one tube end bent upward and one tube end bent downward. On the bottom tube evaporator, on the other hand, both tube ends are bent upward. Further tube evaporator levels could be installed in a refrigeration device having a taller refrigerated container. Said further tube evaporators would all require to be attributed to the same type of design as the middle tube evaporator and would have one tube end bent upward and one tube end bent downward.

The clip-on parts 6 are attached to the side of each tube evaporator 2 in order to secure the evaporator tube 8 in place and to stabilize the tube evaporators 2. The tube evaporators 2 are inserted by means of said clip-on parts 6 into guides 4 which are provided in the side walls of the refrigerated container 1. The tube evaporators 2 are thereby secured in the refrigerated container 1 in their vertical position. For retaining the evaporators horizontally, flexible lugs (not visible in the drawing) are provided on the clip-on parts 6, said flexible lugs latching into recesses 5 in the side walls of the refrigerated container 1.

The clip-on parts 6 also have downward-pointing stops 7. Said stops 7 serve as stoppers for pull-out containers which use the top side of the clip-on parts 6 as a sliding surface. In terms of their height the pull-out containers are designed in such a way that they fit with a small amount of play between the individual tube evaporators 2. They are introduced at a slightly tilted attitude so that the rear wall of the containers can be moved behind the stops 7.

When the containers are inserted said stops 7 serve to prevent the rear wall of the container butting against the rear wall of the refrigerated container 1 and to ensure the necessary air gap is preserved between the two rear walls even with the container fully inserted. This secure retention is achieved in that the stop 7 bears against the front wall of the container and so stops the latter being inserted further.

Since the pull-out containers slide on the clip-on parts 6 rather than directly on the tube evaporators 2, it is not necessary to choose an abrasion-resistant and protective coating for the evaporator tube, but instead the coating can be selected according to totally different criteria. According to the invention the tube evaporators 2 are therefore coated with what is termed an AFP lacquer 11 (anti-freeze protein lacquer). The connecting lines 3 are also coated with said AFP lacquer.

The structure of the evaporator tube 8 is shown in section in FIG. 2. The evaporator tube 8 typically has a metal tube 9. Said metal tube 9 consists of a material which is easy to work—in particular to bend—and has good thermal conductivity. For this reason aluminum is used in many refrigeration devices for producing the evaporator tube 8. The metal tube 9 encloses the conduit 10 for the refrigerant.

The AFP lacquer 11 is applied to the outside of the metal tube 9. Said lacquer contains a protein which prevents the formation of ice crystals. Consequently, although water from the air in the refrigerated container 1 condenses on the evaporator tube 8, it does not transition to the crystalline state. The water can be collected in the conventional manner (not shown here) and ducted to the outside, where it is released into the surrounding air from an evaporation pan which is arranged above a compressor, for example.

The heat transfer from the air in the interior space of the refrigerated container 1 to the refrigerant in the conduit 10 of the evaporator tube 8 consequently does not deteriorate even after many hours of operation of the refrigeration device. An increase in energy consumption due to poorer heat transfer can therefore be ruled out. Furthermore the device does not have to be defrosted. After a defrosting process the interior space of a refrigeration device is normally at the same temperature as the ambient air. Accordingly the temperature of the interior space must first be lowered again after each defrosting process to the normally prevailing temperature level. A not inconsiderable amount of energy is necessary for this. With the refrigeration device according to the invention this energy too can be saved.

### LIST OF REFERENCE SIGNS

1 Refrigerated container

2 Tube evaporator

3 Connecting line

4 Guide

5 Recess

6 Clip-on part

7 Stop

8 Evaporator tube

9 Metal tube

10 Conduit

11 AFP lacquer

1-6. (canceled)

7. A refrigeration device comprising an insulated interior, the insulated interior including at least one refrigerated component part whose surface includes a coating having organic substances which at least one of prevent and restrict a growth of ice crystals on the surface of the component.

8. The refrigeration device as claimed in claim 7, wherein the organic substances have at least one of synthetically created proteins and nucleic acids.

9. The refrigeration device as claimed in claim 8, wherein the proteins are bound to the surface via binding molecules.

10. The refrigeration device as claimed in claim 7, wherein the coating is a lacquer.

11. The refrigeration device as claimed in claim 7, wherein all refrigerant-conducting component parts are provided with the coating.

12. The refrigeration device as claimed in claim 7, wherein the at least one refrigerated component part is an evaporator, and the surface of the evaporator includes the coating.
